(19) United States
(12) Patent Application Publication
(10) Pub. No.: US 2010/0146883 A1
(43) Pub. Date: Jun. 17, 2010

(54) Muntin bar clip for foam spacer

(76) Inventor: Friedrich K. Benkel, Woodruff, SC (US)

Correspondence Address: MONAHAN & MOSES, LLC, 13-B W. WASHINGTON ST., GREENVILLE, SC, 29601, US

(21) Appl. No.: 12/316,823

(22) Filed: Dec. 17, 2008

(51) Int. Cl. E06B 3/964; E06B 3/68

(52) U.S. Cl. 52/204.64; 52/309.4; 52/204.6

(57) ABSTRACT

A muntin bar clip and an insulated glass unit employing the clip are provided, wherein the clip has a base, a tree for engaging the hollow end of a false muntin bar extending upward from the base, and a wedge extending downward from the perimeter of the base, wherein the wedge tapers as it extends away from the base. The wedge is inserted between one of the sheets of glass and a foam spacer frame when the clip is installed. The face of the wedge that is in contact with the foam spacer frame may be provided with a projection, such as an inverted tetrahedron shape, to increase frictional resistance to movement of the clip along the spacer frame, without compromising the seal between the spacer frame and the glass.

This invention is directed to a clip for connecting a “false” muntin bar to a foam spacer frame, where the spacer frame is positioned between two sheets of glass in an insulated glass window unit.

### BACKGROUND OF THE INVENTION

In general, an insulated glass unit (“IGU”) window is constructed with a rectangular spacer frame sandwiched between two sheets of glass. The spacer frame, in combination with a suitable sealant, forms a continuous barrier within the perimeter of the sheets of glass. The space between the sheets of glass may be filled with moisture free air or an inert gas, such as argon. An outer frame is placed around the perimeter of the glass sheets and functions to hold the unit together.

Traditionally, metal spacer frames having a rectangular or “C” shaped cross-section have been employed in IGUs. In place of a metal spacer frame, some IGUs employ a structural foam spacer frame having a solid, rectangular cross-section. The foam spacer frame is claimed to reduce conductive heat transfer between the sheets of glass. The foam is typically provided with a thin-film laminate, which covers the outer perimeter of the foam and extends partially up the sides of the foam that are in contact with the glass. The laminate acts as a barrier both to moisture entering into and gas leaking from the insulated glass unit.

The insulated glass unit window may include decorative muntin bars positioned between the two sheets of glass to create the impression that the viewing area of the window is comprised of many small panes, referred to as “lights,” rather than one large pane. Thus, the muntin bars useful in the present invention are actually “false” muntin bars, in that they do not provide the structural support for individual panes.

The muntin bars are hollow and are secured at one end to the foam spacer frame by a suitable clip. The clip has a first end configured to be inserted into the end of the muntin bar, with projections that engage the inside of the muntin bar to secure the parts together. The first end of the clip is sometimes referred to as a “tree.” The opposite end of the clip is configured to engage the foam spacer frame to prevent movement of the muntin bar relative to the spacer frame, during and after the insulated glass unit is assembled.

Various muntin bar clips have been developed for use in conjunction with the foam spacer frame of an insulated glass unit window. Gieseke, U.S. Pat. No. 6,131,356 discloses a muntin bar clip having a tip end that is inserted between the side edge of the foam spacer and a sheet of glass. The tip end may terminate in one or more prongs or as a blunt end. In a subsequent development, Gieseke U.S. Pat. No. 6,494,002 B1 discloses that the tip end, which is inserted between the foam spacer frame and the glass, may be provided with spikes. The spikes are oriented to penetrate into the foam and secure the muntin bar in a fixed position.

GKT Glas, DE 202 13 054 U1 and Polowinczak, US 2005/0086880 disclose muntin bar clips for use with foam spacer frames having a “lip” that is inserted between the foam and the glass, wherein the lip element of the clip is provided with protrusions along the side in contact with the side edge of the foam spacer. The protrusions engage the foam spacer frame to resist movement of the end clip and muntin bar assembly.

Reichert, US 2006/0112654 A1 and Gieseke, US 2006/0096215 A1 disclose muntin bar clips having a blade-like protrusion, which engage a corresponding slit cut into the foam spacer frame.

Hatwig-Führer GmbH & Co., DE 296 02 634 U1 disclose a feather element (2) positioned within a recess in the muntin bar clip. The feather element engages the spacer frame when the clip is compressed between sheets of glass, thereby securing the position of the muntin bar.

Despite the aforementioned developments there remains a strong felt need in the art for a clip for securing a muntin bar to a foam spacer frame element in an insulated glass unit that does not break the seal between the spacer frame element and the glass, secures the position of the muntin bar relative to the spacer frame element, is relatively uncomplicated to manufacture, and facilitates assembly of the insulated glass unit.

### SUMMARY OF THE INVENTION

The present invention includes both a muntin bar clip for securing a muntin bar to a foam spacer frame, as well as an insulated glass unit employing the muntin bar clip.

The insulated glass unit is constructed of at least two sheets of glass held in spaced-apart parallel alignment. A foam spacer frame is sandwiched between the sheets of glass and within the perimeter of the sheets. The spacer frame maintains the glass sheets a fixed distance apart and creates a barrier to the flow of gas into or out of the space between the sheets. A sealant or adhesive, such as butyl rubber, may be used in conjunction with the foam spacer frame to further seal the unit. The spacer frame is characterized by an inside surface, facing the interior of the IGU, an outside surface, facing away from the interior of the IGU, and first and second side surfaces, each facing one of the sheets of glass. The spacer frame may be provided with a film laminate to enhance the barrier properties of the foam, as is known to those skilled in the art. For example, a film laminate may be applied around the perimeter of the outside of the spacer frame and extend partially up the first and second sides of the spacer frame.

An outer frame is placed around the perimeter of the sheets of glass to hold the unit together, optionally with the application of an additional sealant or suitable gasket.

During assembly of the insulated glass unit, a muntin bar assembly is placed within the perimeter of the spacer frame, between the two sheets of glass. The muntin bar assembly may be a single muntin bar, spanning from one side of the spacer frame to the opposite side of the spacer frame, which creates the visual effect of dividing the unit into two lights. Or, the muntin bar assembly may include multiple intersecting muntin bars, which create the effect of dividing the unit into four, six or more individual lights. The present invention is not limited to rectangular insulated glass units and may include virtually any geometry of unit that incorporates a muntin bar, including round, oval and semi-circular insulated glass units.

A clip is used to secure an end of the muntin bar to the spacer frame, thereby maintaining the muntin bar in the desired orientation. The clip has a base, characterized by a top side, a bottom side and a perimeter. A means to engage the end of the muntin bar extends outward from the top side of the base of the clip. Typically, the muntin bars will each have a hollow end to accommodate insertion of the muntin bar engaging means of the clip. By way of example, the muntin bar engaging means may be a projection corresponding to the shape of the muntin bar, which frictionally engages the inside of the muntin bar when the clip is inserted. The projection is sometimes referred to in the industry as a “tree,” because of elements that extend like branches from a center trunk and flex upon insertion of the clip into the muntin bar and create frictional resistance to separation of the components. The design of a clip structure useful for securely connecting one end of the clip to a corresponding muntin bar is known to persons skilled in the art.

The bottom side of the clip base overlays the inside surface of the spacer frame. The perimeter of the clip base extends to a first side of the spacer frame and abuts the sheet of glass adjacent such first side of the spacer frame. The perimeter of the clip may optionally extend in the opposite direction to the second side of the spacer frame and abut the adjacent sheet of glass, thereby limiting sideways movement of the clip in either direction.

The clip has a wedge extending from the bottom of the clip base, adjacent the perimeter of the base, at the location where the perimeter extends to the first side of the spacer frame. The wedge is inserted between the first side of the spacer frame and the adjacent sheet of glass, when the clip is installed in the insulated glass unit, thereby preventing movement of the clip relative to the spacer frame. The wedge has an outside face that is substantially perpendicular to the bottom of the base and is capable of lying flat against the sheet of glass. The inside face of the wedge is forced against the foam to create frictional resistance to movement of the clip along the spacer frame, without creating a gap that can defeat the seal between the spacer frame and the glass. The thickness of the wedge, measured from the outside face of the wedge to the inside face of the wedge, tapers along at least a portion of the length of the wedge, as the wedge extends from the clip base.

The inside face of the wedge may be provided with a projection extending inwardly, that is, in the direction opposite the outside face. The projection further compresses the foam spacer, creating additional frictional resistance to movement of the clip along the spacer frame. The projection may have an edge formed by the intersection of two facets. The edge of the projection may be slanted toward the outside face (away from the foam spacer frame), as the wedge extends away from the base.

In one embodiment, the projection may be in the shape of an inverted tetrahedron, having a base and an apex, with the tetrahedron base facing the bottom of the clip base and the apex pointed away from the bottom of the clip base. One side of the tetrahedron is oriented toward the outside face of the wedge, and an edge of the tetrahedron forms the outermost extension of the inside face of the wedge.

The present invention represents numerous advantages including ease of insertion and resistance to movement of the clip along the spacer frame, without adversely affecting the gas seal between the spacer frame and adjacent glass sheet, as well as being economical to manufacture.

### BRIEF DESCRIPTION OF THE DRAWINGS

FIG. 1 is a perspective view of the muntin bar clip viewed from below.

FIG. 2 is an enlarged view of the wedge element of the clip shown in FIG. 2.

FIG. 3 is a partial end view of the clip showing the base and the wedge element.

FIG. 4 is a partial side view of the clip showing the base and the inside face of the wedge element.

FIG. 5 is a perspective view of the insulated glass unit, with a partial cutaway of a muntin bar to expose the clip.

FIG. 6 is a cross-sectional view of the insulated glass unit shown in FIG. 5, taken along line 6-6.

FIG. 7 is an enlarged view of a portion of the cross-sectional view shown in FIG. 6.

### DETAILED DESCRIPTION OF THE INVENTION

Without limiting the scope of the invention, the preferred embodiments and features are hereinafter set forth. All United States patents cited in the specification are incorporated by reference.

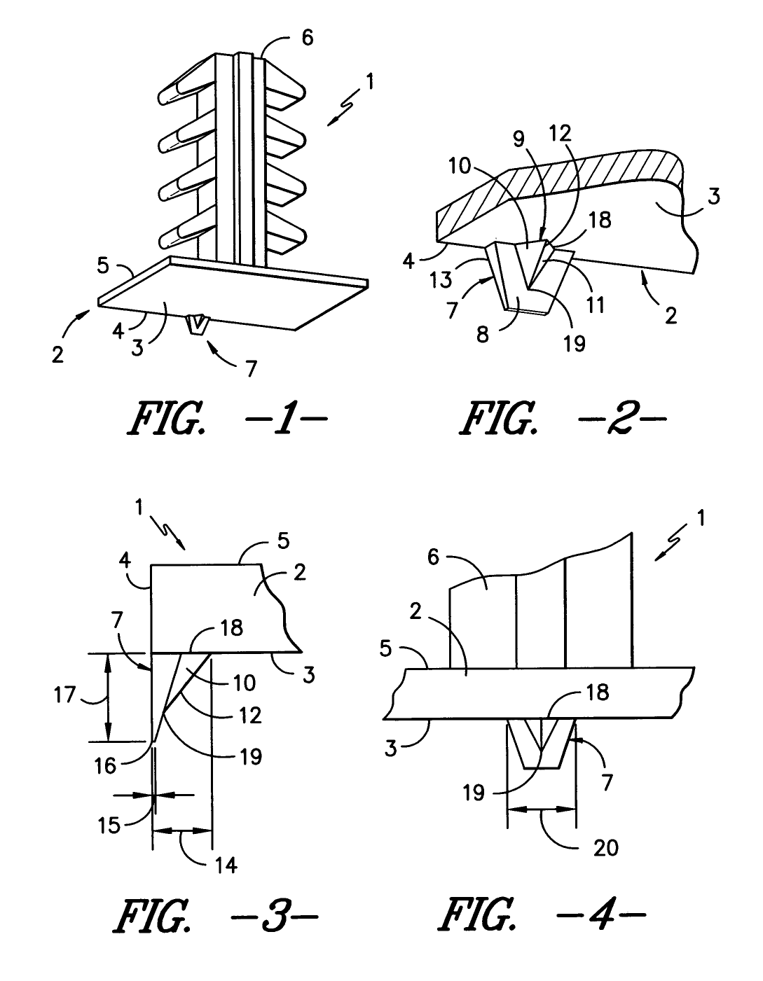

Referring to FIG. 1, clip 1 has base 2 with bottom 3, perimeter 4 and top 5. Tree 6 extends upward from top 5 of base 2 and represents an embodiment of the muntin bar engaging means. Wedge 7 extends downward from bottom 3 of base 2.

An enlarged view of wedge 7 is shown in FIG. 2. Wedge 7 has inside face 8 with projection 9. Facets 10 and 11 of projection 9 form edge 12. Outside face 13 is located on the opposite side of wedge 7 from inside face 8.

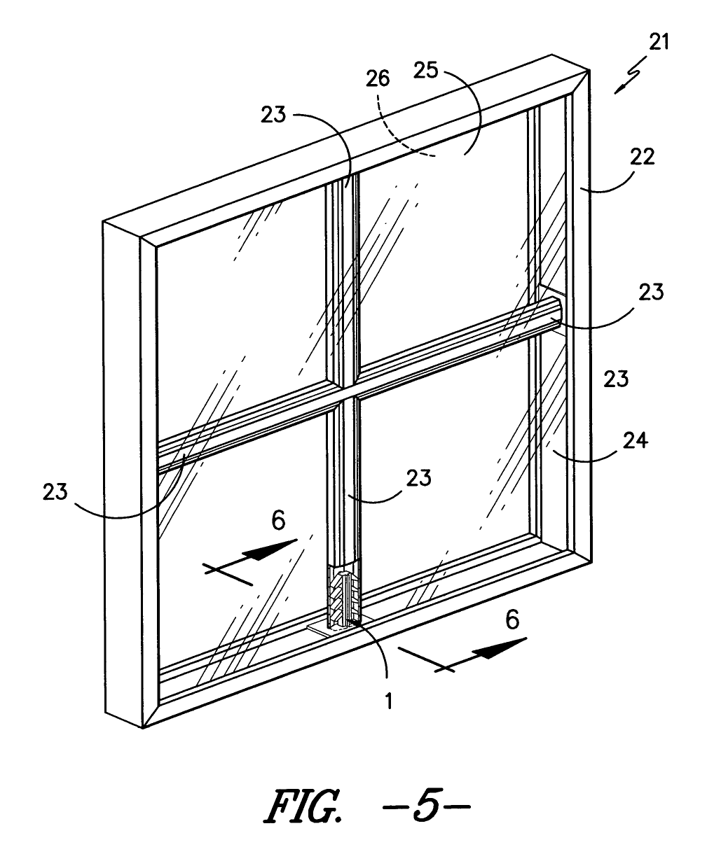

Referring to FIG. 3, outside face 13 of wedge 7 is substantially perpendicular to base 2 to provide to lie against one of the sheets of glass forming the insulating glass unit, as hereinafter described. Wedge 7 tapers as it extends away from base 2, from a first thickness 14, adjacent base 2, to a second thickness 15, at the tip 16. By way of example the thickness of wedge 7 may range from a maximum of 3 to 0.3 mm to a minimum of from 0.5 to 0.1 mm. The length 17 of wedge 7 may extend the full thickness of the foam spacer frame. Nevertheless, in applications where a film laminate is applied to the spacer frame, it has been found to be advantageous to provide wedge 7 with a length that does not contact the film laminate, thereby decreasing the likelihood of the seal between the spacer frame and the glass being compromised. By way of example, the length 17 of wedge 7 may range from 4 to 1 mm.

Projection 9 of inside face 8 may be in the shape of an inverted tetrahedron, as shown in detail in FIGS. 2-4. For example, facets 10 and 11 comprise two sides of the tetrahedron. Another side of the tetrahedron is oriented toward outside face 13. Additionally, the tetrahedron shape is characterized by a base 18, oriented toward bottom 3 of clip base 2, and apex 19, oriented away from bottom 3 of clip base 2.

A feature of one embodiment of the invention can be seen in the depiction of clip 1 in FIG. 4. The width 20 of wedge 7 does not extend along the entire side of base 2 that is configured to abut a sheet of glass in the insulated glass unit. Rather, width 20 of wedge 7 is a fraction of the width of the side of base 2 from which wedge 7 extends. By way of example, width 18, measured at the widest part, may range from 8 to 1 mm.

Clip 1 can be easily manufactured by injection molding in a simple open-close mold, that is, without the need for slides or other moving components. Clip 1 may be made from a wide variety of thermoplastic resins. Suitable thermoplastic resins include polyolefin resins, such as polyethylene, polypropylene and ethylene/propylene co-polymers; polyamide resins, including nylon 6 and nylon 6,6; polyester resins, such as PET; and acrylonitrile/butadiene/styrene (ABS) resins. Wedge 7 is preferably solid, without holes or elements intended to move relative to each other.

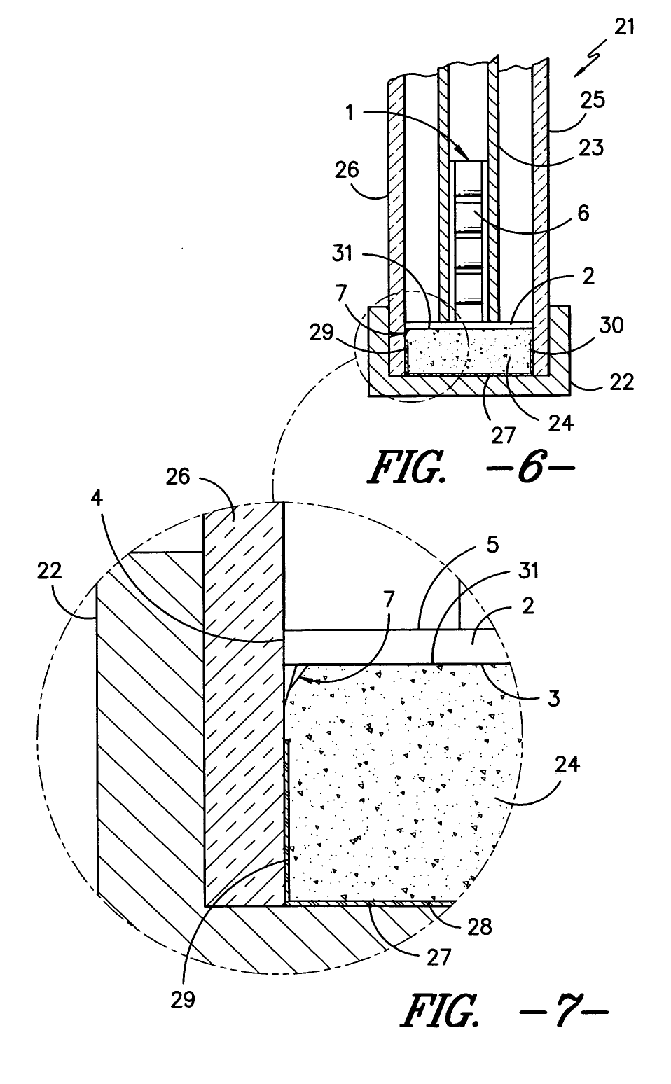

FIG. 5 shows assembled insulated glass unit 21 having outer frame 22 and muntin bars 23. Foam spacer frame 24 is sandwiched between sheets of glass 25 and 26, such that spacer frame 24 forms a continuous seal within the perimeter of the glass. Clip 1 is shown in phantom lines inserted into an end of muntin bar 23.

The arrangement of the components of insulated glass unit 21 can be seen FIGS. 6 and 7 in more detail. Spacer frame 24 has a rectangular cross-section. Film laminate 27 wraps around the outside 28 of spacer frame 24 and extends partially up each of sides 29 and 30 of spacer frame 24. Examples of suitable film laminates include polymer films, which may optionally be metalized, including biaxially oriented polyester films in general and Mylar® in particular, and metal films. An adhesive may be applied to the outer surface of the film laminate, that is, the side facing away from the foam spacer frame, to assist in assembly and promote sealing.

Base 2 of clip 1 overlays the inside 31 of spacer frame 24, so that wedge 7 is inserted between glass 26 and side 29 of spacer frame 24. Tip 16 of wedge 7 terminates without contacting film laminate 27. It can be understood that wedge 7 compresses a portion of side 29 of spacer frame 24. Additionally, edge 12 of projection 9 extends into spacer frame 24 to further restrict movement of clip 1 along spacer frame 24.

There are, of course, many alternative embodiments of the invention intended to be included in the scope of the following claims.

What i claim is:

1. A clip for securing an end of a muntin bar to a foam spacer frame in an insulated glass unit, comprising:
(a) a base having a top, a bottom and a perimeter;
(b) a means to engage the end of the muntin bar, the muntin bar engaging means extending from the top of the base;
(c) a wedge having a length and thickness, wherein the wedge extends from the bottom of the base in a direction opposite the muntin bar engaging means and is positioned adjacent the perimeter of the base, wherein the thickness of the wedge tapers along the length in a direction away from the base, and wherein the wedge has an inside face and an outside face, relative to the perimeter of the base, wherein the outside face of the wedge is perpendicular to the base and is capable of lying flat against a sheet of glass when the clip is in installed in an insulated glass unit.

2. The clip of claim 1, wherein the inside face of the wedge comprises an inwardly extending projection.

3. The clip of claim 2, wherein the projection comprises an edge formed by the intersection of two facets.

4. The clip of claim 2, wherein the edge of the projection slants toward the outside face as the wedge extends away from the base.

5. The clip of claim 1, wherein the inside face of the wedge comprises an inverted tetrahedron having a base and an apex, wherein the tetrahedron is positioned with an inwardly projecting edge, wherein the edge slants toward the outside face as the wedge extends away from the base.

6. The clip of claim 1, wherein the wedge has a width of from 8 to 1 mm.

7. The clip of claim 1, wherein the length of the wedge is from 4 to 1 mm.

8. The clip of claim 7, wherein the thickness of the wedge ranges from a maximum of 3 to 0.3 mm to a minimum of less from 0.5 to 0.1 mm.

9. The clip of claim 1, wherein the inside face of the wedge comprises an inwardly extending projection.

10. The clip of claim 1, wherein the clip is manufactured by injection molding a thermoplastic resin using an open/close mold, without slides.

11. An insulated glass unit comprising:
(a) first and second sheets of glass in parallel alignment;
(b) a foam spacer frame sandwiched between and within a perimeter of the sheets of glass, wherein the spacer frame has an inside, an outside and first and second side edges facing the first and second sheets of glass, respectively;
(c) a muntin bar positioned within the spacer frame between the sheets of glass; and
(d) a clip for securing an end of the muntin bar to the spacer frame, the clip comprising (i) a base having a top, a bottom and a perimeter; (ii) a means to engage the end of the muntin bar, the muntin bar engaging means extending from the top of the base; and (iii) a wedge having a length and thickness, wherein the wedge extends from the bottom of the base in a direction opposite the muntin bar engaging means and is positioned adjacent the perimeter of the base, wherein the thickness of the wedge tapers along the length in a direction away from the base, and wherein the wedge has an inside face and an outside face, relative to the perimeter of the base, wherein the outside face of the wedge is perpendicular to the base and is capable of lying flat against a sheet of glass when the clip is in installed in an insulated glass unit.

12. The insulated glass unit of claim 11, wherein the inside face of the clip wedge comprises an inwardly extending projection.

13. The insulated glass unit of claim 12, wherein the projection comprises an edge formed by the intersection of two facets.

14. The insulated glass unit of claim 13, wherein the edge of the projection slants toward the outside face as the wedge extends away from the base.

15. The insulated glass unit of claim 11, wherein the inside face of the clip wedge comprises an inverted tetrahedron having a base and an apex, wherein the tetrahedron is positioned with an edge projecting inward relative to the perimeter of the base, wherein the edge slants toward the outside face as the wedge extends away from the base.

16. The insulated glass unit of claim 11, wherein the wedge has a width of from 8 to 1 mm.

17. The insulated glass unit of claim 11, wherein the length of the clip wedge is from 4 to 1 mm.

18. The insulated glass unit of claim 17, wherein the thickness of the clip wedge ranges from a maximum of 3 to 0.3 mm to a minimum of from 0.5 to 0.1 mm.

19. The insulated glass unit of claim 11, wherein the spacer frame has a film laminate extending around the outside and partially up the first and second sides of the spacer frame, and wherein the clip wedge terminates prior to contacting the film laminate.

20. The insulated glass unit of claim 11, wherein the inside face of the clip wedge comprises an inwardly extending projection.
